(19) United States
(12) Patent Application Publication
(10) Pub. No.: US 2006/0069659 A1
(43) Pub. Date: Mar. 30, 2006

(54) Defect monitoring system

(76) Inventors: Michael S. Gatov, Gresham, OR (US); Deborah A. Leek, Washougal, WA (US); Bruce J. Whitefield, Camas, WA (US)

Correspondence Address: LSI LOGIC CORPORATION, 1621 BARBER LANE, MS: D-106, MILPITAS, CA, 95035, US

(21) Appl. No.: 10/951,647

(22) Filed: Sep. 28, 2004

(51) Int. Cl. G06F 17/00

(52) U.S. Cl. 705/400

(57) ABSTRACT

A method of determining a cost effective number of corrective tests to perform on a process experiencing process excursions. A test cost for each corrective test is determined, and a total test cost for each of an incremental number of corrective tests is calculated. An effect of each corrective test on a reduction in the process excursions is determined, as is also the lost revenue for each process excursion. A reduction in the lost revenue for each of the incremental number of corrective tests is calculated, based at least in part on the effect of each corrective test on the reduction in process excursions and the revenue lost for each process excursion. An overall cost for each of the incremental number of corrective tests is calculated, based at least in part on a sum of the total test cost and the reduction in the lost revenue for each of the incremental number of corrective tests. A minimum value of the overall costs is found, and that incremental number of corrective tests that is associated with the minimum value of the overall costs is selected as the cost effective number of corrective tests to perform.

### FIELD

This invention relates to the field of integrated circuit fabrication. More particularly, this invention relates to a method for determining whether or not to run tests to improve process yield, and if so, how many tests to run.

### BACKGROUND

Modern integrated circuits are fabricated using extremely complicated and sensitive tools and processes. As the term is used herein, “integrated circuit” includes devices such as those formed on monolithic semiconducting substrates, such as those formed of group IV materials like silicon or germanium, or group III-V compounds like gallium arsenide, or mixtures of such materials. The term includes all types of devices formed, such as memory and logic, and all designs of such devices, such as MOS and bipolar. The term also comprehends applications such as flat panel displays, solar cells, and charge coupled devices.

Process engineers typically estimate the frequency and number of qualification tests and inspections that are performed on the substrates processed through a given process step or piece of equipment. These estimates are more or less just guesses, based in part on the engineer's knowledge of the equipment and the process being tested. In general, the greater the knowledge or feel for the process or equipment, the better the estimate for when and how many tests should be performed. However, knowledge and feel for the process varies widely, and such subjective decisions also tend to vary widely, even for a single engineer from day to day.

One aspect of testing that is typically overlooked is the true cost of the test, which is defined as the cost of inspection compared to the cost benefit of preventing a process excursion. For example, intensive testing that is designed to determine and eliminate a given problem may actually exceed the cost savings that is realized by eliminating the problem. Alternately, a relatively low frequency of testing may be insufficient to minimize or even reduce the overall cost of the problem, and thus just costs more money to perform but yields insufficient results, or no results at all.

What is needed, therefore, is a system which receives as input information about a given process, and then determines an appropriate level of testing for the process, such that the overall cost of testing in relation to the cost of the defects that the testing is designed to reduce, is preferably reduced, and most preferably minimized.

### SUMMARY

The above and other needs are met by a method of determining a cost effective number of corrective tests to perform on a process experiencing process excursions. A test cost for each corrective test is determined, and a total test cost for each of an incremental number of corrective tests is calculated. An effect of each corrective test on a reduction in the process excursions is determined, as is also the lost revenue for each process excursion. A reduction in the lost revenue for each of the incremental number of corrective tests is calculated, based at least in part on the effect of each corrective test on the reduction in process excursions and the revenue lost for each process excursion. An overall cost for each of the incremental number of corrective tests is calculated, based at least in part on a sum of the total test cost and the reduction in the lost revenue for each of the incremental number of corrective tests. A minimum value of the overall costs is found, and that incremental number of corrective tests that is associated with the minimum value of the overall costs is selected as the cost effective number of corrective tests to perform.

In this manner, the various embodiments of the invention as described herein provide a method for determining a plan for monitoring a production tool or process, such as integrated circuit fabrication tools and processes, based on desired criteria. The process monitor plan preferably includes the set-up and methods used for qualifying a process or tool, as well as sampling strategies that can be used for generally monitoring product yields or other defect indicators. The defect monitor method preferably determines a sampling frequency, based at least in part on the point at which the charted costs of processing excursions intersects or otherwise finds a minima with the charted costs associated with the testing to be performed.

In various embodiments, the effect of each corrective test is to reduce the process excursions by half. Preferably the total test cost for each of the incremental number of corrective tests includes a cost of materials for each corrective test, a cost to perform each corrective test, and a cost to analyze each corrective test. The lost revenue for each process excursion preferably includes the selling price of product lost in the process excursion reduced by the fabrication cost of the product lost in the process excursion.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a depiction of a first portion of a defect monitoring system information screen according to a preferred embodiment of the invention.

FIG. 2 is a depiction of a second portion of a defect monitoring system information screen according to a preferred embodiment of the invention.

FIG. 3 is a depiction of a third portion of a defect monitoring system information screen according to a preferred embodiment of the invention.

FIG. 4 is a depiction of a fourth portion of a defect monitoring system information screen according to a preferred embodiment of the invention.

FIG. 5 is a depiction of a fifth portion of a defect monitoring system information screen according to a preferred embodiment of the invention.

FIG. 6 is a depiction of a defect monitoring system cost of testing chart according to a preferred embodiment of the invention.

### DETAILED DESCRIPTION

The defect monitor system as described herein receives as input the answers to a series of questions related to a process flow, tools, and equipment—generally referred to herein as the process. Once the data is input to the system, output for the system is calculated, preferably using data from one or more of the sources including finance, average yield performance data, yield impact of defects or other excursions—generally referred to as problems herein, cost of inspection and analysis tools, and cost of testing materials. The results of the output variables are preferably charted in a graph that is evaluated to determine the point where the combined cost of testing and revenue losses curve is below a desired value, and preferably is minimized. At this point, the resultant cost evaluation tends to provide the optimal sampling frequency value for the process.

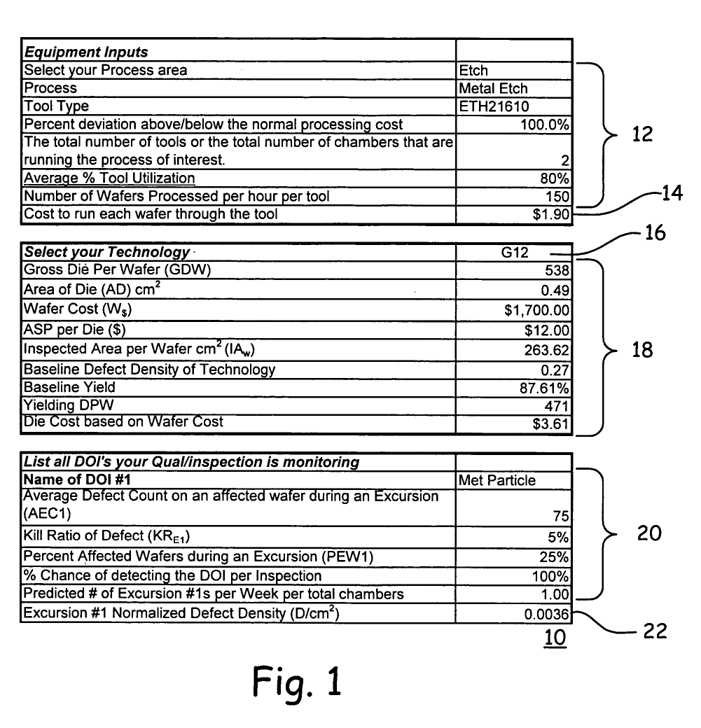

With reference now to FIG. 1, there is depicted a first portion of the defect monitor system 10 according to a preferred embodiment of the present invention. Fields 12 are a portion of the data input screen, where information in regard to the process is input to the system 10. The information for the fields 12 are preferably provided by the user, and output field 14 is preferably calculated by the system.

For example, as depicted in FIG. 1, the process area for which a defect monitor plan is desired is preferably selected, such as the etch process area. Other process areas that could be selected, for example, include polishing, diffusion, photolithography, and thin films. This is preferably selected from a drop down menu of process areas that, when selected, provide a set of customized fields that have been previously programmed and are appropriate for the process area that has been selected. For example, when an etch process area is selected, the process field includes all of the different etch processes that are available, which can be selected in a drop down box. As depicted, the metal etch process has been selected.

When a specific process has been selected, it preferably also provides a set of customized fields that have been previously programmed and are appropriate for the process that has been selected. For example, when the metal etch is selected, the tool type field includes all of the tools that are relevant for that type of etch, and the user can select the specific processing tool of interest. Such an action preferably provides further automated input to the system 10. Alternately, however, all of the various fields can be filled in a freeform manner, where further selections are not automatically made based on earlier input.

The tool type is also preferably designated, such as is depicted in FIG. 1. Again, upon selection of the specific tool under review, preferably other information as required or desired can be automatically filled in or requested by the system 10.

The percent that the tool deviates from normal operating cost is also preferably input. A value of 100% preferably indicates that the tool does not deviate from normal operating cost. Also preferably input is the number of chambers that are running the specific process in question. In the example as depicted in FIG. 1, the number of chambers running the metal etch process on the designated tool is two. This is an example of information that could be, in some embodiments, automatically filled in by the system 10. The percent of utilization of the tool is also preferably input to the system 10. For example, as depicted in FIG. 1, the tool has an 80% usage. This information could also be automatically collected from an engineering database, based on the designation of the tool type, as previously entered.

The number of wafers processed per hour is also preferably entered into the system 10. Again, this information could be manually entered, or could be automatically looked up in an engineering database and entered by the system 10 without user intervention, based on previously entered information, such as the tool type. The cost to run each wafer through the tool 14 is preferably calculated by the system 10 from the information that has previously been entered, and from engineering or other databases. Alternately, this cost could be input by the user.

Thus, the first block of information as described above and depicted in FIG. 1 tends to be mainly concerned with the process under investigation, as primarily defined by the piece of equipment—or processing tool—in which the process is performed. Of course, it is also comprehended by the present invention to perform the analysis as further described herein on a process that isn't performed in a piece of equipment, per se. For example, the methods described herein could also be applied to manual processing, in which some of the same information in regard to the process is entered either automatically by the system 10 or manually by the user, as described above.

The next block of information as describe below and depicted in FIG. 1 with reference number 16 and 18 is generally directed toward the technology of the devices that are being processed through the process as defined in the first block of information, and described above. For example, as given in line 16, a technology designation can be entered into the system 10 by the user, and the rest of the information 18 in regard to the devices that are fabricated by that technology can preferably then all be automatically entered by the system 10.

The information in block 18 preferably includes data such as the number of dice per wafer, the area of each die, the total wafer cost, the average selling price per die, the amount of area on each wafer that is inspected during a given inspection routine, the current defect density of the selected technology, the current yield of the selected technology, the number of good or yielding dice per wafer, and the cost of each good device based on the total wafer cost. It is appreciated that this information, which is preferably automatically retrieved by and entered into the system 10 based on the designation of the technology as given in line 16, could also be manually entered or modified in some embodiments by the user.

Preferably, the user is then given the option to enter at least one—and preferably more—designation of the defect in which the user is interested, or as depicted in FIG. 1, the DOI'S. The information that is preferably provided by the user in regard to the defect of interest is given in block 20 of FIG. 1. For example, the user preferably provides a name for the defect, which in the example as depicted is “Met Particle.” In some embodiments, this defect designation could be selected such as from a drop down list of defects, which list is populated based on the designation of the process or tool type from block 12, as described above. In other embodiments the designation and other information is manually entered.

In some embodiments, once the defect name is input, the balance of the information in block 20 and line 22 is automatically entered by the system 10, such as from engineering and other databases. However, in other embodiments the balance of the information in block 20 is manually input by the user. Such information preferably includes data such as the average defect count on an affected wafer during an excursion, the kill ratio of the defect, the percent of total wafers affected during an excursion, the percent change of detecting the defect per inspection, and the anticipated number of excursions per week. From this information, the normalized defect density for the defect can be calculated and entered into line 22, either automatically by the system 10, or manually by the user.

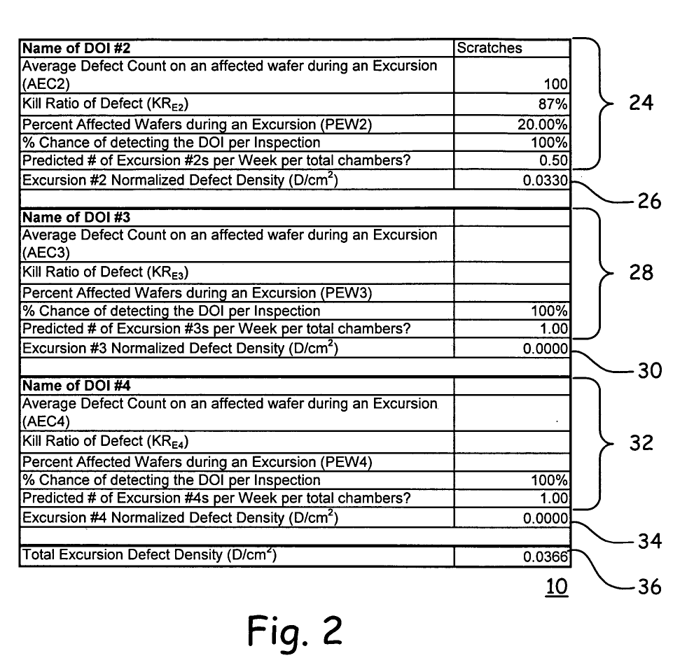

Preferably, the system 10 is configured to receive information in regard to several defects of interest, as depicted in FIG. 2, which information can be input to the system 10 according to one or more of the methods as described above. The system 10 can be also configured with a data input line for the user to designate the number of different defects that are to be analyzed. The system 10 could then just produce enough data input blocks 20, 24, 28, and 32 to handle the designated number of different defects. Alternately, a number of input blocks can be provided by the system 10, and the system 10 then subsequently uses data only from those input blocks that have been populated, as designated by the user. Preferably, once all of the information in regard to the different defects of interest is entered, the system computes a total excursion defect density, which is most preferably the sum of all the individual defect densities 22, 26, 30, and 34.

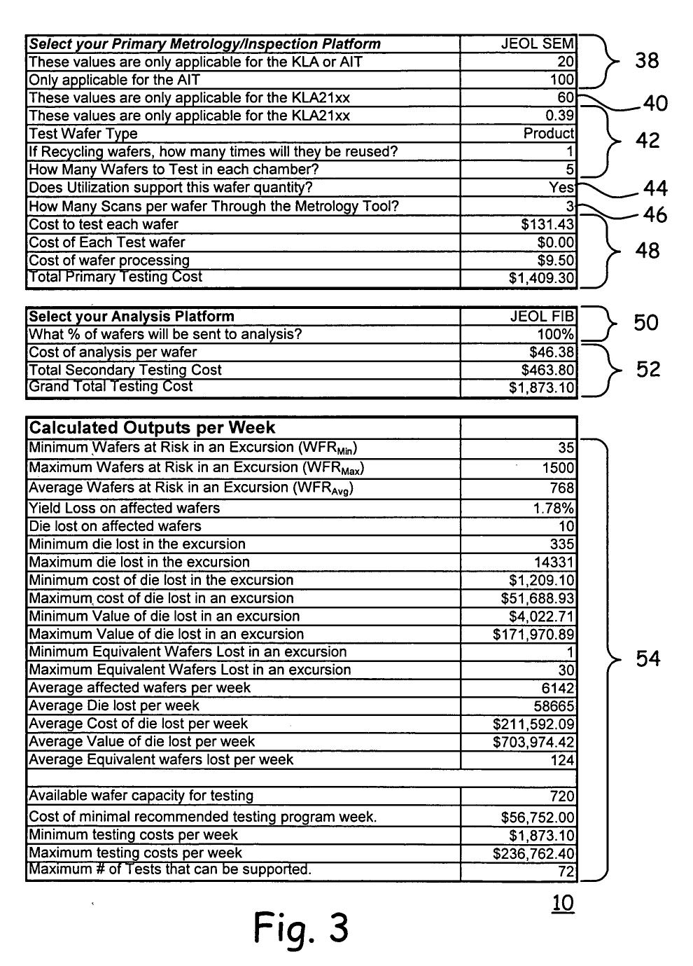

The relevant information in regard to the metrology or inspection tool is then preferably entered into the system 10, as generally depicted in FIG. 3. The operating and equipment costs to perform different measurements or inspections can vary considerably and will have a significant impact on the optimum sample rate. In block 28, the name of the metrology or inspection system is preferably designated by the user and the remaining information about the costs of using the tool is automatically selected by the system 10 based previously entered data. In the example as depicted in FIG. 3, the platform is a defect review SEM, for which cost and operating data has been entered. In the case that a new tool is selected, the individual cost and operating data would be entered manually by the user.

As given in block 42, the type of wafer that will be used for the test is preferably identified, which in the example as depicted in FIG. 3 is a product wafer. Alternately, a dummy wafer or some type of specialized test wafer could be specified, depending on the test in question. The number of times that a test wafer is to be reused is also input to the system 10. In the example as depicted, the test wafer is only to be used once, as designated in block 42. The number of wafers to be used in each chamber to be tested is also designated to the system 10, which in the example is given as five different wafers.

It is appreciated that in some embodiments the system 10 can receive as input the designation of a test methodology—or a pre-named test design—which would then fill in such information automatically. In this manner, tests that are designed for specific types of excursions can be saved and then quickly reloaded in the system 10, to determine whether it is cost effective to run the pre-saved test under the current conditions, and if so, how to administer the test, as explained in more detail below.

As given in line 44, the system 10 is informed as to whether the current use of the equipment to be tested supports the level of testing as previously input, or whether the current use of the equipment is so heavy that the equipment does not have the capacity to run the number of tests indicated. This input is preferably automatically generated by the system 10 using the data that has already been input, but in some embodiments the designation can be overridden by the user.

Line 46 then requests as input the number of times that each test wafer will be scanned through the metrology tool, which in the present example is three. Block 48 then uses the data that has been input as described above, and preferably determines values such as the cost to test each of the test wafers, the cost of each test wafer itself, and the cost to process the test wafers, and then sums these values into the total primary cost of testing. These testing costs are preferably calculated using whatever costing methods are applicable for the users factory.

In the next block as depicted in FIG. 3, the system 10 then requests information in regard to the analysis that will be performed on the test wafers. For example, the analysis platform is designated in block 50. As mentioned above, if the current test design being analyzed by the system 10 has been predefined, then this analysis platform may be automatically designated by the system 10. However, in other embodiments, the user enters the designation of the analysis platform. This designation of the analysis platform may be made, for example, in a free form manner, or selected such as from a drop down list of analysis platforms.

Additional information in regard to the analysis system, as described more completely below, is in some embodiments automatically entered by the system 10, based at least in part upon the designation of the platform. In other embodiments at least some of the information, such as the percentage of the test wafers that will be sent to analysis, is entered manually. The information in block 52 is preferably automatically calculated and entered by the system 10, but in some embodiments this information can be overridden by the user, such as may be desirable when performing additional what-if investigations.

This information preferably includes the cost of analysis per wafer, which is then preferably used in association with the number of test wafers to calculate the total secondary testing cost, all of which is preferably added together with the total primary testing cost from block 48 to yield the grand total testing cost as given in block 52.

The rest of the information as depicted in block 54 of FIG. 3 is preferably automatically computed by the system 10, using information such as the data entered in the prior portions of the system 10 by the user, and information that is automatically gathered by the system 10 from engineering and other databases, which is preferably based at least in part on the information that is entered by the user. This computed or retrieved information preferably includes the ranges for different data classes, such as the minimum, maximum, and average values for a given variable.

These variables preferably include, for example, the number of wafers that are put at risk during a process excursion, the yield loss on an affected wafer, the number of dice that are lost on an affected wafer, the number of dice that are lost in an excursion, the cost of the dice lost in the excursion, the selling value of the dice lost in the excursion, the number of wafers affected each week, the number of dice lost each week, the cost and value of the dice lost each week, the equivalent number of wafers lost each week, the wafer capacity that is available for testing, the cost of the minimal recommended testing program per week as determined by the system 10, the testing costs, and the maximum number of test that can be supported—or in other words, the number of tests that the equipment could run when it is not running production.

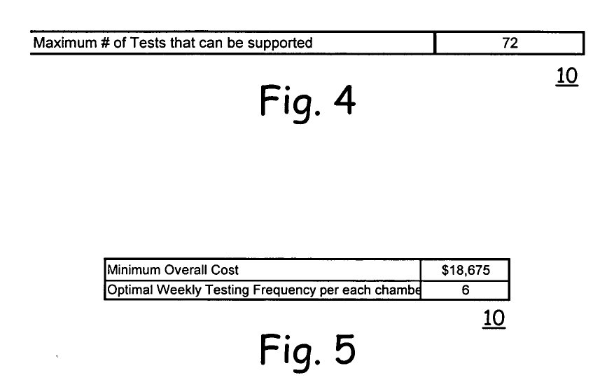

As depicted in FIG. 5, the minimum cost of the testing is also presented by the system 10, as well as the optimal weekly testing frequency. This final value, as computed by the system 10, and displayed again in FIG. 4, is important, because it indicates that any testing in addition to the number of test so determined by the system 10 will actually cost more money to perform than would be regained by further reduction of the excursions, based upon the assumed relationship between the number of tests performed and the reduction in excursions expected. Thus, this value stands as a warning to the engineer to not exceed the number of tests as given. Therefore, the system 10 preferably provides the engineer with the cost that the tests will incur, and then further preferably provides the engineer with an optimal number of tests to run within a given period of time. The period as used in the examples described herein is one week. However, it is appreciated that the system 10 could be adapted to other periods of time, as desired.

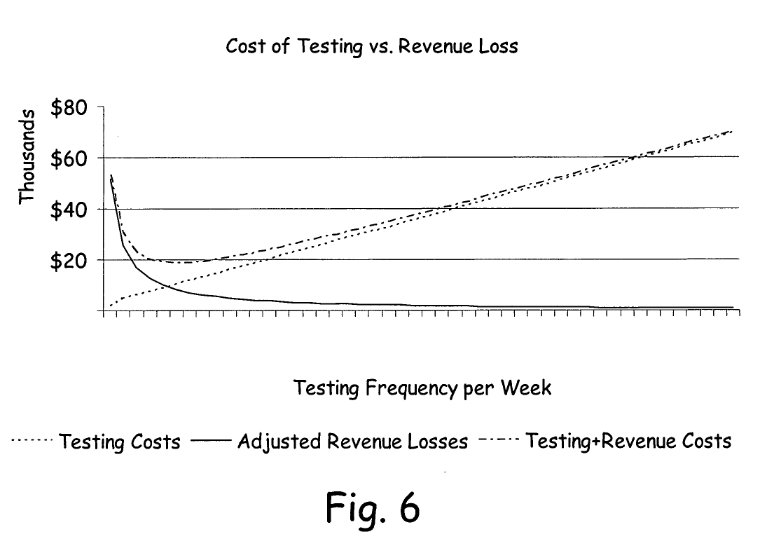

FIG. 6 depicts a chart of graphed data, on which some of the calculated information presented by the system 10, as described above, is preferably based. The chart depicts three data series, which are the testing costs, which increase as the number of tests increases, the revenue losses, which decreases as the testing decreases the yield loss due to the reduction in excursions, and then the sum of the testing costs and the revenue losses. These data sets are preferably graphed in dollars versus an incremental number of tests, which is preferably interpreted as the testing frequency per week. However, other metrics could also be used for the graph.

As depicted in FIG. 6, as additional tests are performed each week, the cost of such testing continually increases without a cap—except when such testing reaches the capacity of the process in question, at which point no additional testing—and no production—could be run. The revenue losses drop as testing is performed and excursions are reduced. However, it is preferably assumed that no amount of testing—except for infinite testing—would reduce yield loss to zero, and so the revenue losses only approach zero as testing increases.

The assumed relationship between testing and reduction in excursions, or in other words the effect of each test on the number of excursions, is preferably that each incremental test drops the number of excursions in half. However, other relationships could also be assumed or determined, such as from historical engineering data in which the number of excursions is correlated to the tests that have been run.

Thus, the sum of the two curves produces a line which initially drops as the initial revenue losses provides the greatest influence, but then starts to rise as the incremental benefits of additional testing continually reduce, while the incremental costs of additional testing remain more or less constant. This combined data set goes through a minima, where—by definition—the total cost of testing is also at a minimum. As depicted in FIG. 6 for the example as used herein, this minima occurs nearest the integer value of six tests per week. Thus, this indicates that a level of six tests per week is the best balance of direct test costs incurred versus revenue losses saved.

The system 10 as described herein provides an effective evaluation of process and tool monitor plans to minimize overall costs. The system 10 provides engineering with a non-esoteric and consistent method to evaluate the costs associated with defects and monitor plans. Equipment and materials vendors can provide their own yield data and finance costs for the system 10 for the same type of monitor evaluation. The system 10 can be adapted for any type of industry that tests or monitors their tool or process, by modifying the type of variables and equations as applicable.

The system 10 is based on the concept that there is a cost associated with running qualification tests. This is often overlooked in lieu of the costs of an excursion that leads to yield losses. Conventional practice is to treat a testing resource as part of the cost of doing business. The present invention compares the costs of the tests to the costs associated with a yield-loss excursion. As newer metrology tools become available, their exotic features don't come cheap. They are expensive to purchase, maintain and run. As a result, there are some excursions that would cost more to detect and remedy than they cost in yield loss. The use of this system 10 helps focus the efforts on major yield hits, quantify the per-wafer test costs, and compare them to the expected gain in yield.

The system 10 is unique, in that it takes into account the actual revenue losses on a technology basis. In other words, the average selling prices of dice based on basic technology platforms, as described above. This helps tune the defect impact based on the cost of the dice. The system 10 recognizes the difference between metrology tools and analysis tools. The first tool locates the defect, and the second tool identifies the defect. Sometimes both are used in a qualification. The system 10 realizes the feature-set differences between certain metrology tools. Some tools have optional pixel-size variables that impact the run-time and the number of images that must be analyzed by engineers. This variable is activated if specific metrology tools are selected for use, as described above and depicted in FIG. 3.

The system 10 assumes that each qualification test cuts the potential yield loss in half. As a result, as the number (N) of qualifications goes up, the yield loss decreases as a function of (1/N). The intersection point between the (1/N) yield loss function and the linear cost of qualifications is the minimum total cost of the excursion. This intersection point is used to determine the actual “N” value, which would tell us the best number of qualifications to run each week. Current practice is to do whatever it takes to minimize the number of excursions. The new practice based on the present invention is to minimize the total relevant cost of production, based on test costs and revenue loss. Some excursions would be costlier to eliminate because of the cost of the qualifications.

The system 10 also preferably determines whether the proposed qualification frequency can be supported by the current tool utilization. Some tools run so close to maximum utilization, that the impact of more frequent qualifications would be a hit to product cycle time. In this case, additional analysis is required by the engineer to determine the best course of action.

The system 10 is preferably implemented on a computing device. For example, the system 10 may be implemented as a dedicated combination of hardware and software that performs no other functions than those as described above. However, in more preferred embodiments, the system 10 is implemented as a set of program instructions that are operable to instruct a general purpose computing platform, such as a personal computer, to perform the steps mentioned above. Most preferably, the system 10 is implemented as a file that operates within a spreadsheet program environment.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of determining a cost effective number of corrective tests to perform on a process experiencing process excursions, the method comprising the steps of:
determining a test cost for each corrective test,
calculating a total test cost for each of an incremental number of corrective tests,
determining an effect of each corrective test on a reduction in the process excursions,
determining lost revenue for each process excursion,
calculating a reduction in the lost revenue for each of the incremental number of corrective tests, based at least in part on the effect of each corrective test on the reduction in process excursions and the revenue lost for each process excursion,
calculating an overall cost for each of the incremental number of corrective tests based at least in part on a sum of the total test cost and the reduction in the lost revenue for each of the incremental number of corrective tests,
finding a minimum value of the overall costs, and
selecting as the cost effective number of corrective tests to perform that incremental number of corrective tests that is associated with the minimum value of the overall costs.

2. The method of claim 1, wherein the effect of each corrective test is to reduce the process excursions by half.

3. The method of claim 1, wherein the total test cost for each of the incremental number of corrective tests includes a cost of materials for each corrective test, a cost to perform each corrective test, and a cost to analyze each corrective test.

4. The method of claim 1, wherein the lost revenue for each process excursion includes a selling price of product lost in the process excursion reduced by a fabrication cost of the product lost in the process excursion.

5. The method of claim 1, further comprising the step of graphing the total test cost for each of the incremental number of corrective tests.

6. The method of claim 1, further comprising the step of graphing the reduction in the lost revenue for each of the incremental number of corrective tests.

7. The method of claim 1, further comprising the step of graphing the overall cost for each of the incremental number of corrective tests.

8. The method of claim 1, further comprising the steps of graphing on a chart:
the total test cost for each of the incremental number of corrective tests.
the reduction in the lost revenue for each of the incremental number of corrective tests, and
the overall cost for each of the incremental number of corrective tests.

9. The method of claim 1, further comprising the steps of:
graphing on a chart,
the total test cost for each of the incremental number of corrective tests,
the reduction in the lost revenue for each of the incremental number of corrective tests, and
the overall cost for each of the incremental number of corrective tests, and graphically finding the minimum value of the overall costs.

10. A method of determining a cost effective number of corrective tests to perform on a process experiencing process excursions, the method comprising the steps of:
determining a test cost for each corrective test,
calculating a total test cost for each of an incremental number of corrective tests,
determining an effect of each corrective test on a reduction in the process excursions,
determining lost revenue for each process excursion,
calculating a reduction in the lost revenue for each of the incremental number of corrective tests, based at least in part on the effect of each corrective test on the reduction in process excursions and the revenue lost for each process excursion,
calculating an overall cost for each of the incremental number of corrective tests based at least in part on a sum of the total test cost and the reduction in the lost revenue for each of the incremental number of corrective tests,
graphing on a chart,
the total test cost for each of the incremental number of corrective tests,
the reduction in the lost revenue for each of the incremental number of corrective tests, and
the overall cost for each of the incremental number of corrective tests,
graphically finding a minimum value of the overall costs, and
selecting as the cost effective number of corrective tests to perform that incremental number of corrective tests that is associated with the minimum value of the overall costs.

11. The method of claim 10, wherein the effect of each corrective test is to reduce the process excursions by half.

12. The method of claim 10, wherein the total test cost for each of the incremental number of corrective tests includes a cost of materials for each corrective test, a cost to perform each corrective test, and a cost to analyze each corrective test.

13. The method of claim 10, wherein the lost revenue for each process excursion includes a selling price of product lost in the process excursion reduced by a fabrication cost of the product lost in the process excursion.

14. A method of determining a cost effective number of corrective tests to perform on a process experiencing process excursions, the method comprising the steps of:
determining a test cost for each corrective test, calculating a total test cost for each of an incremental number of corrective tests, wherein the total test cost for each of the incremental number of corrective tests includes a cost of materials for each corrective test, a cost to perform each corrective test, and a cost to analyze each corrective test,
determining an effect of each corrective test on a reduction in the process excursions,
determining lost revenue for each process excursion, wherein the lost revenue for each process excursion includes a selling price of product lost in the process excursion reduced by a fabrication cost of the product lost in the process excursion,
calculating a reduction in the lost revenue for each of the incremental number of corrective tests, based at least in part on the effect of each corrective test on the reduction in process excursions and the revenue lost for each process excursion,
calculating an overall cost for each of the incremental number of corrective tests based at least in part on a sum of the total test cost and the reduction in the lost revenue for each of the incremental number of corrective tests,
finding a minimum value of the overall costs, and
selecting as the cost effective number of corrective tests to perform that incremental number of corrective tests that is associated with the minimum value of the overall costs.

15. The method of claim 14, wherein the effect of each corrective test is to reduce the process excursions by half.

16. The method of claim 14, further comprising the step of graphing the total test cost for each of the incremental number of corrective tests.

17. The method of claim 14, further comprising the step of graphing the reduction in the lost revenue for each of the incremental number of corrective tests.

18. The method of claim 14, further comprising the step of graphing the overall cost for each of the incremental number of corrective tests.

19. The method of claim 14, further comprising the steps of graphing on a chart:
the total test cost for each of the incremental number of corrective tests.
the reduction in the lost revenue for each of the incremental number of corrective tests, and
the overall cost for each of the incremental number of corrective tests.

20. The method of claim 14, further comprising the steps of:
graphing on a chart,
the total test cost for each of the incremental number of corrective tests,
the reduction in the lost revenue for each of the incremental number of corrective tests, and
the overall cost for each of the incremental number of corrective tests, and
graphically finding the minimum value of the overall costs.
